(19) United States
(12) Patent Application Publication
(10) Pub. No.: US 2018/0255008 A1
(43) Pub. Date: Sep. 6, 2018

(54) COMPUTER PROGRAM PRODUCT, INFORMATION PROCESSING APPARATUS, AND COMMUNICATION METHOD

(71) Applicant: DeployGate Inc., Tokyo (JP)

(72) Inventors: Yuki FUJISAKI, Tokyo (JP); Kazuto YASUDA, Tokyo (JP)

(21) Appl. No.: 15/906,642

(22) Filed: Feb. 27, 2018

(30) Foreign Application Priority Data
Mar. 1, 2017 (JP) 2017-037875

(51) Int. Cl. H04L 12/58; G06F 8/77; G06F 3/0484

(52) U.S. Cl. CPC H04L 51/046; G06F 3/04845; G06F 8/77; H04L 51/10

(57) ABSTRACT

Communication program code is communication program code incorporated into an application and continuously displays a startup button on an application screen, operates as a function of the application when the startup button is operated, and allows a talk between a user and a developer. A communication function allows the developer and the user to talk in real time, and hence the user of the application can easily give feedback, such as report of usability and problems, to the developer in real time.

### CROSS-REFERENCE TO RELATED APPLICATIONS

This application is based on Japanese Patent Application No. 2017-037875, the content of which is incorporated herein by reference.

### BACKGROUND OF THE INVENTION

### 1. Field of the Invention

The present invention relates to a computer program product, an information processing apparatus, and a communication method.

### 2. Description of Related Art

In the development of an application program (hereinafter, also referred to simply as an “application”), a tester tries out an application under development and feeds back usability, bugs, and so on to the developer. It was often the case that a method for providing feedback from the tester to the developer was not any particular one, though it typically included communication tools using the Internet, such as electronic mail, chat, and messaging.

Japanese Patent No. 5956512 (hereinafter, referred to as “Patent Literature 1”) describes that, in order to evaluate a game with a simple operation in real time, a “Good button” is assigned to a particular operating button on a controller provided for the game device and a “Bad button” is assigned to another operating button different from said particular operating button, so that the game content can be evaluated while the game is in progress by pressing either of the operating buttons.

However, the method disclosed in Patent Literature 1 is specific to game devices and cannot be employed with various types of applications regardless of their type. In addition, although Patent Literature 1 indicates that evaluations of the game content identified with “Good” or “Bad” are aggregated, and the results of analysis are fed back to the developer, such feedback does not allow the developer to clearly recognize an improvement that should be made to the application, such as a correction of a problem.

### BRIEF SUMMARY OF THE INVENTION

The present invention has been conceived in light of these circumstances, and an object thereof is to provide a computer program product, an information processing apparatus, and a communication method that allow users of an application program to easily perform real-time feedback, such as reporting problems and usability, to the developer regardless of the type of the application program.

In order to solve the above-described problem, a computer program product, an information processing apparatus, and a communication method according to the present invention employ the following solutions.

In order to solve the above-described problem, a “computer program product”, serving as one aspect of the present invention, includes a non-transitory computer-readable medium storing communication program code that is incorporated into an application program, the communication program code being for causing a computer to function as: an image display control unit for continuously displaying a prescribed image on a screen on which the application program is operating; and a communication unit operating as a function of the application program when the prescribed image is operated and allowing communication between a user and a developer.

In order to solve the above-described problem, a “computer program product”, serving as one aspect of the present invention, includes a non-transitory computer-readable medium storing communication program code that is incorporated into an application program, the communication program code being for causing a computer to function as: an image display control unit for continuously displaying a prescribed image on a screen on which the application program is operating; and a startup unit for starting up the communication program that allows communication between a user and a developer when the prescribed image is operated.

In order to solve the above-described problem, an “information processing apparatus”, serving as one aspect of the present invention, is an information processing apparatus in which an application program having a communication program incorporated thereinto is installed and includes: an image display control unit for continuously displaying a prescribed image on a screen on which the application program is operating; and a communication unit operating as a function of the application program when the prescribed image is operated and allowing communication between a user and a developer.

In order to solve the above-described problem, a “communication method”, serving as one aspect of the present invention, is a communication method using a communication program incorporated into an application program and includes: a first step of continuously displaying a prescribed image on a screen on which the application program is operating; and a second step of operating as a function of the application program when the prescribed image is operated and allowing communication between a user and a developer.

Various types of technical constraints exemplified below may be applied to the above-described “computer program product”. In addition, the same technical constraints may be applied to the “information processing apparatus” and the “communication method”.

When the user performs communication using the communication unit, the communication unit in the application program on the developer side may display communication content from the user and allow the developer to make a reply.

The communication unit may display communication content made by another user.

The communication unit may allow an operator to search for past communication content.

The prescribed image may move to a position according to a drag operation performed by an operator.

The communication unit may transmit a screen image showing the screen on which the application program is operating.

The communication unit may transmit the screen image to which writing is performed.

The communication unit may capture the screen image for each prescribed operation performed on the application program and apply a process based on the prescribed operation to the screen image.

The communication unit may transmit a moving image showing a change in the screen on which the application program is operating.

The communication unit may transmit a log of an information processing apparatus in which the application program is operating.

The communication unit may transmit the log when the operating application program abnormally ends.

The communication unit may synchronize communication content with another application program or another web service that are pre-registered.

The communication program may be incorporated into a web site instead of the application program.

The present invention affords an advantage in that, regardless of the type of the application, the user of the application program can easily give feedback, such as reports of usability and problems, to the developer in real time.

### BRIEF DESCRIPTION OF THE SEVERAL VIEWS OF THE DRAWINGS

FIG. 1 is a configuration diagram of a communication system according to an embodiment of the present invention.

FIG. 2 is a block diagram showing the electrical configuration of a user terminal and a developer terminal according to an embodiment of the present invention.

FIG. 3 is a diagram depicting an application screen according to an embodiment of the present invention.

FIG. 4 is a diagram depicting a main screen of a communication function according to an embodiment of the present invention.

FIG. 5 is a diagram depicting a thread display screen of a communication function according to an embodiment of the present invention.

FIG. 6 is a diagram depicting a talk transmission operation screen of a communication function according to an embodiment of the present invention.

FIG. 7 is a diagram depicting an SC image to which writing is performed according to an embodiment of the present invention.

FIG. 8 is a functional block diagram related to a communication function according to an embodiment of the present invention.

FIG. 9 is a flowchart showing the flow of communication processing according to an embodiment of the present invention.

### DETAILED DESCRIPTION OF THE INVENTION

One embodiment of a computer program product, an information processing apparatus, and a communication method according to the present invention will now be described with reference to the drawings.

### 1. Configuration of Communication System

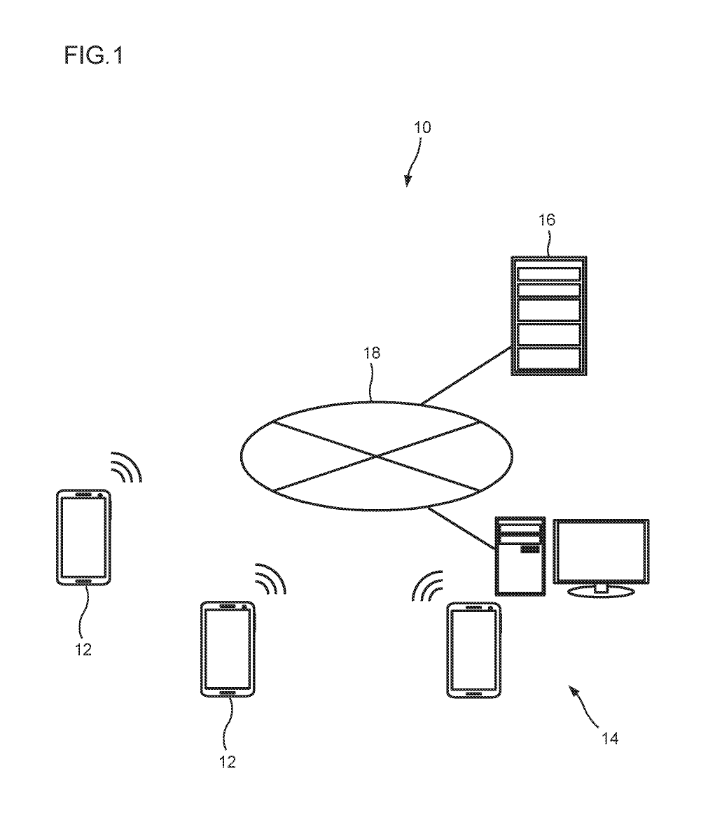

FIG. 1 is a configuration diagram of a communication system 10 according to this embodiment.

The communication system 10 includes user terminals 12, a developer terminal 14, and a server 16 and allows data to be transmitted and received via a communication line 18. The communication line 18 is, for example, a wide-area communication line provided by a telecommunications carrier.

The same application program (hereinafter, also referred to simply as an “application”) is installed in the user terminals 12 and the developer terminal 14. This application is produced by a developer who uses the developer terminal 14.

Each of the user terminals 12 is an information processing apparatus possessed by a user of the application and is, for example, a smartphone, a tablet terminal, or a personal computer. The user includes not only a person who operates a completed application but also a tester (try-out person) who operates an application under development on a trial basis. As one example, this embodiment will be described on the assumption that the user is a tester. In addition, the user serving as a tester need not be only a person belonging to the organization developing the application but also a person not belonging to that organization, i.e., a so-called general user.

The developer terminal 14 is an information processing apparatus possessed by a developer of the application and is, for example, a smartphone, a tablet terminal, or a personal computer. Note that the developer may develop the application by using not only a single developer terminal 14 but also a plurality of the developer terminals 14 (e.g., a smartphone or a personal computer).

In the following description, the user terminals 12 and the developer terminal 14 are collectively referred to as a “terminal” in the case where they need not be discriminated from each other. In addition, the users and the developer are collectively referred to as “operators” in the case where they need not be discriminated from each other. In addition, the number of users and the number of developers may be individually one or more than one.

Although the type and the function of the application according to this embodiment are not limited, the communication program according to this embodiment is incorporated into the application. The communication program is developed by a corporation different from the corporation to which the developer of the application belongs and adds, to the application, a communication function that allows communication between the users and the developer. In short, the communication program according to this embodiment is an SDK (Software Development Kit). The developer of the application downloads the communication program from the server 16 via a web site and incorporates the communication program into the application by following a prescribed procedure. By doing so, the developer of the application can install the communication function into the application being developed without having to develop a communication function himself/herself.

The server 16 stores the communication program as described above. In addition, the server 16 functions as a real-time server and transmits and receives various types of communication data between the user terminals 12 and the developer terminal 14 when a terminal performs the communication function. More specifically, when a user terminal 12 performs the communication function and transmits communication content, the server 16 transmits the communication content to the developer terminal 14. In addition, when the developer terminal 14 performs the communication function and transmits communication content, the server 16 transmits the communication content to the user terminals 12.

In addition, the application to be installed in each of the user terminals 12 is transmitted, for example, from the developer terminal 14 to the server 16 and is stored in the server 16. The user terminal 12 accesses the server 16 and installs the application by downloading the application from the server 16. Note that the application distribution method is not limited to this and may be distributed from, for example, an application store.

### 2. Configurations of User Terminal 12 and Developer Terminal 14

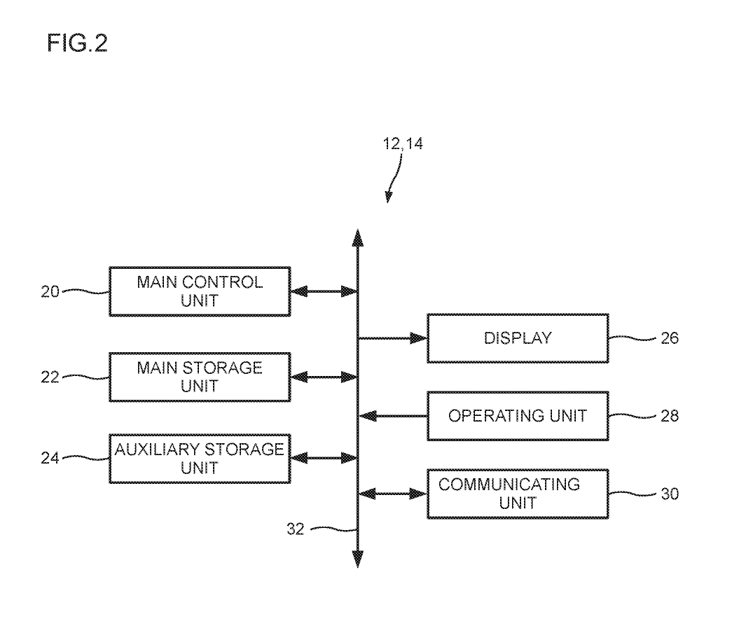

FIG. 2 is a block diagram showing the electrical configuration of the user terminal 12 and the developer terminal 14. The terminals have substantially the same electrical configuration, which includes a main control unit 20, a main storage unit 22, an auxiliary storage unit 24, a display 26, an operating unit 28, and a communicating unit 30.

The main control unit 20 is, for example, a CPU (Central Processing Unit), a microprocessor, and a DSP (Digital Signal Processor) and controls the operation of the entire terminal.

The main storage unit 22 is configured from, for example, a RAM (Random Access Memory) and a DRAM (Dynamic Random Access Memory) and is used, for example, as a working area when processing based on various types of programs is executed by the main control unit 20.

The auxiliary storage unit 24 is a nonvolatile memory, such as a flash memory or an HDD (Hard Disk Drive), and stores various types of data, such as images, and programs etc. used for processing performed by the main control unit 20. The programs stored in the auxiliary storage unit 24 are, for example, the OS (Operating System) for achieving basic functions of the terminal, drivers for controlling various types of hardware, and applications for achieving electronic mail, web browsing, and other various types of functions.

The display 26 is, for example, an LCD (Liquid Crystal Display) and displays images on the basis of processing performed by the main control unit 20.

The operating unit 28 is used to input various types of operations to the terminal and is, for example, a touch panel, a keyboard, a mouse, a touchpad, or a button.

The communicating unit 30 has a function for connecting to the communication line 18, is, for example, a NIC (Network Interface Controller), and connects to a communication network such as a mobile telephone network. Note that, instead of or together with the NIC, the communicating unit 30 may have a function for connecting to a wireless LAN (Local Area Network), a function for connecting to a wireless WAN (Wide Area Network), and a function for enabling close-range wireless communication such as the Bluetooth (registered trademark), infrared (IR) communication, and so on.

The main control unit 20, the main storage unit 22, the auxiliary storage unit 24, the display 26, the operating unit 28, and the communicating unit 30 are electrically connected to one another via a system bus 32. Therefore, the main control unit 20 can access the main storage unit 22 and the auxiliary storage unit 24, display images on the display 26, perceive the state of an operation performed on the operating unit 28, access various types of communication networks and other terminals via the communicating unit 30, and so on.

Note that when a terminal is a smartphone or a tablet terminal, the terminal includes, in addition to the above, a configuration required for telephony functions, such as a microphone and a speaker, various types of sensors such as an acceleration sensor, a camera, and so on.

### 3. Outline of the Communication Function

The communication function according to this embodiment operates as a function of the application when the operator operates a prescribed image displayed while the application is running and enables communication between the users and the developer. More specifically, “communication” is defined as exchanges between the developer and the users using text sentences and images (hereinafter referred to as a “talk”) in real time. When a user performs a talk using the communication function, the communication function of the application running in the developer terminal 14 displays talk details from that user and enables the developer to make a reply. On the other hand, when the developer performs a talk using the communication function, the communication function of the application running in each of the user terminals 12 displays talk details from that developer and enables the user to make a reply. In this manner, the communication function according to this embodiment allows the users and the developer to perform exchanges bidirectionally and also allows exchanges between users. Note that users and the developer who can use the communication function are pre-registered.

As described above, because the communication function allows the developer and each of the users to perform a talk in real time, the user of the application can easily feed back, for example, report of usability and problems in real time to the developer.

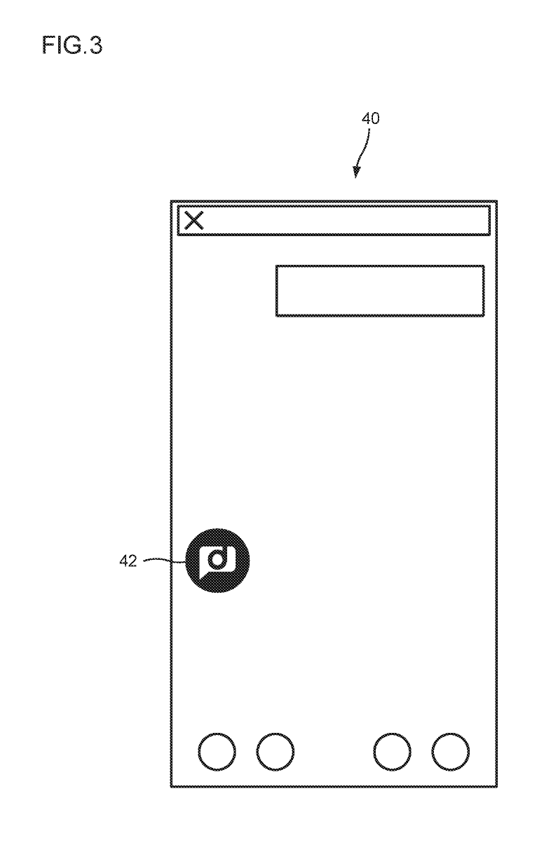

The main functions of the communication function will be described below with reference to FIGS. 3 to 7.

### 3-1. Startup Button

FIG. 3 is one example of a screen (an image displayed on the display 26 and hereinafter, referred to as an “application screen”) 40 shown when the application having the communication program incorporated therein is running. The following description assumes that the display 26 is a touch panel display.

Although the example in FIG. 3 shows the application screen 40 displayed on the portrait-oriented display 26, this is just one example, and the display 26 may be landscape-oriented, in which case the layout is changed as appropriate.

On the application screen 40, the above-described prescribed image is continuously displayed on the application screen 40 in order to allow the startup of the communication program. One example of this prescribed image is a button (hereinafter referred to as a “startup button”) 42. “Continuously displayed” means that display continues even when the application screen 40 is switched.

The startup button 42 is displayed at a preset position on the application screen 40. However, because the startup button 42 is continuously displayed even when the application screen 40 is switched, the startup button 42 will overlap another image when the application screen 40 is switched, possibly hampering the operation of the application. For this reason, the startup button 42 is movable to a position according to a drag operation performed by the operator. By doing so, the startup button 42 moves to an arbitrary position specified by the operator, thus preventing the startup button 42 from overlapping another image and hampering the operation of the application.

When the operator performs an operation on the startup button 42, the communication program starts up, and the communication function is executed in the application. Note that this operation includes, for example, tapping and clicking.

### 3-2. Main Screen and Talk Display

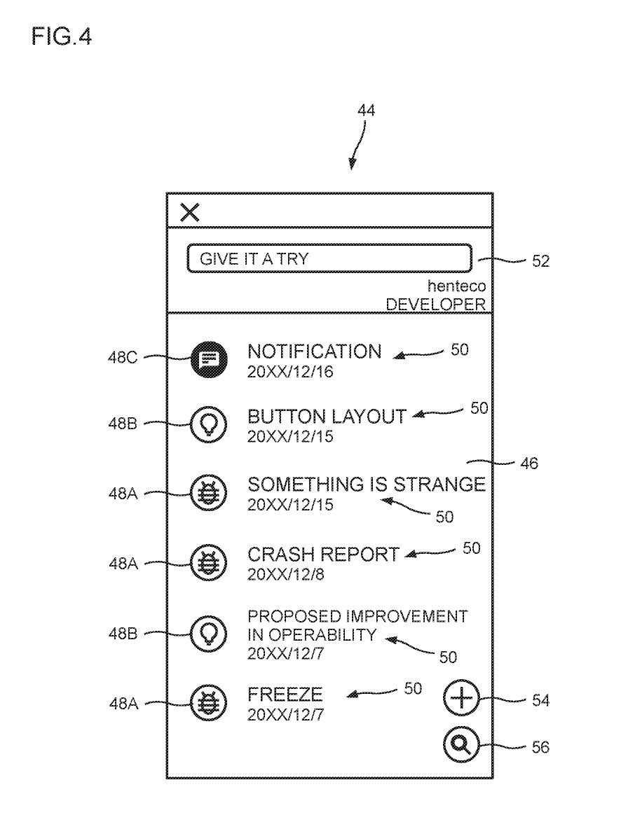

FIG. 4 is a diagram depicting a main screen 44 that is displayed on the display 26 when the communication function is executed. Note that when the screen is switched to the screen for executing the communication function, the startup button 42 is not displayed.

The main screen 44 is provided with a talk listing area 46 in which talks between the developer and users are listed. As one example, the talk listing area 46 time-sequentially lists talk displays 50, each of which is a set of items such as the title of the talk, the start date/time of the talk, and a theme mark 48. The title of a talk is arbitrarily input by the operator who has started the talk. The theme mark 48 is an indication showing the theme of a talk and is set by the operator who has started the talk.

Themes according to this embodiment include “Problem”, “Improvement”, and “Other”. “Problem” is selected in a case where a talk for reporting a problem with the application is to be performed. “Improvement” is selected in a case where a talk for proposing an improvement in the application is to be performed. “Other” is selected in a case where a talk not included in a problem report or an improvement proposal is to be performed. In FIG. 4, a theme mark 48A indicates “Problem”, a theme mark 48B indicates “Improvement”, and a theme mark 48C indicates “Other”. Note that in addition to the above-described themes, a new theme may be created by an operator.

The above-described items included in each of the talk displays 50 are only one example, and other items, such as information about the operator who has started the talk, information about the operator who has replied, and an unread mark showing that an unread talk is included, may be included.

The talks displayed in the talk listing area 46 can be sorted by theme. For example, when an operator performs an operation on the theme mark 48, the talks are sorted by theme. Note that sorting may be performed not only by theme but also by other conditions, such as reordering talks in descending order of a sympathy count, which will be described later. By sorting talks by sympathy count, the developer can determine, for example, the priority of improvements in the application.

The upper section of the main screen 44 is provided with a message display area 52, which displays, for example, a message to be reported from the developer to the user. In the lower right section of the main screen 44, a new talk create button 54 and a search button 56 are displayed.

The new talk create button 54 is operated when the operator is to start a new talk.

The search button 56 allows the operator to search for past talk details. When an operator performs an operation on the search button 56, a text input screen is displayed, and the operator can search for a talk by inputting a keyword to the text input screen. The user can check for talks having a topic of a problem or improvement proposal noticed by the user himself/herself, thereby preventing the user from making a duplicated report.

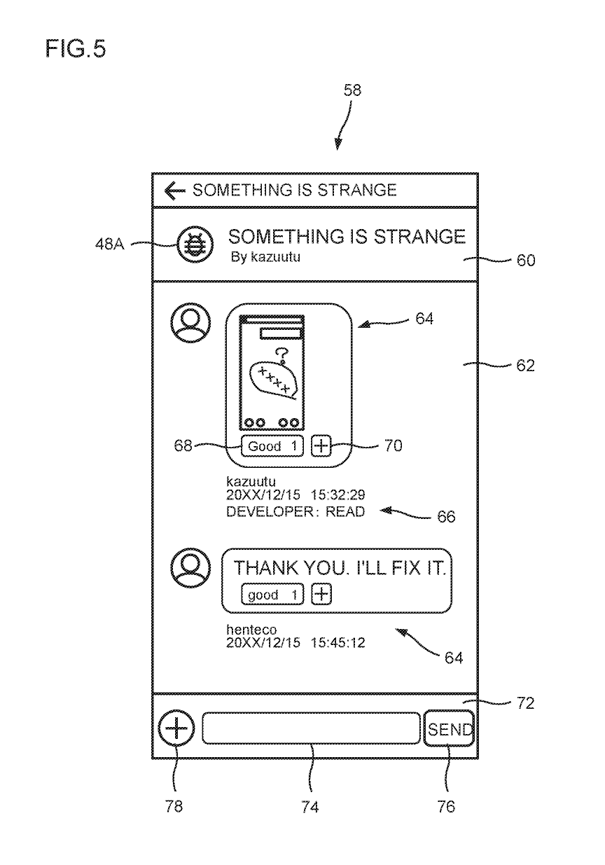

FIG. 5 is a thread screen 58 that is displayed on the display 26 when an operation for selecting a talk display 50 displayed on the main screen 44 is performed. The thread screen 58 displays, as a thread, a series of talks including transmitted talk details and talk details in reply to such talk details.

The upper section of the thread screen 58 is provided with a title display area 60. The title display area 60 displays the title of the selected talk, information about the operator who has started the talk, and a theme mark 48.

A talk-detail display area 62 is provided below the title display area 60. The talk-detail display area 62 time-sequentially displays talk details 64, which are exchanges between the user and the developer, in chronological order from top to bottom, together with information about the person who transmitted the talk and the transmission date/time.

Any operator can start a talk. However, when a user (tester) starts a talk, the transmission destination is the developer. On the other hand, when the developer starts a talk, the transmission destinations are all users. Any operator can reply to a talk. However, the reply destination is the operator that has started the talk. The talk details 64 displayed on the thread screen 58 can be browsed by another user using his/her own user terminal 12, i.e., a user other than the operators involved in the talk. In short, the communication function displays talk details 64 made by other users. For this reason, another user can also reply to the talk detail 64. Note that with a setting, the communication function may disable replies from other users.

A read mark 66 and a sympathy count indication 68 are displayed at each of the talk details 64. The read mark 66 is automatically applied when the operator at the transmission destination displays the talk detail 64 on his/her own terminal. The sympathy count indication 68 is increased by one each time a person who shows sympathy with or an interest in the talk detail 64 operates a sympathy button 70.

A reply operation area 72 is provided below the talk-detail display area 62. The reply operation area 72 is operated when a reply is made to the talk detail 64 displayed on the thread screen 58. More specifically, when an operator wishes to make a reply, the reply is made by inputting a text sentence in a text box 74 displayed in the reply operation area 72 and operating a send button 76. Note that an image and so on can be appended to the reply by operating an add button 78. The talk detail 64 that has been transmitted as a reply is appended to the bottom of the thread.

### 3-3. Transmission of a Talk

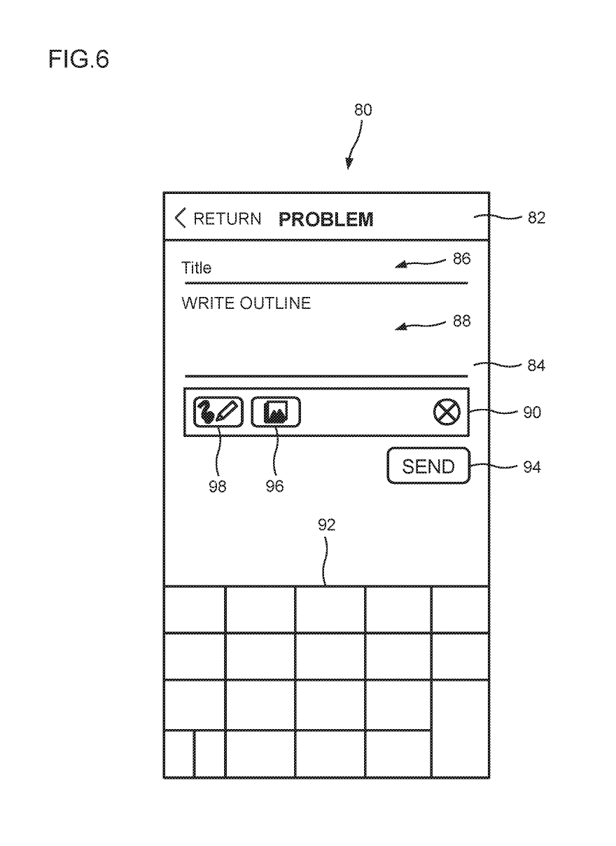

FIG. 6 is a talk transmission operation screen 80 that is displayed on the display 26 when the new talk create button 54 displayed on the main screen 44 is operated. Note that the talk transmission operation screen 80 may also be displayed when the reply operation area 72 is operated.

The upper section of the talk transmission operation screen 80 is provided with a theme display area 82. The theme display area 82 displays the theme of a newly started talk. Note that the theme is selected by the operator in the theme display area 82.

An input area 84 is provided below the theme display area 82. The input area 84 displays a title input area 86, a talk-detail input area 88, an image attach operation area 90, and a software keyboard 92, in that order from top to bottom. Characters, numeric characters, symbols, and so on can be input to the title input area 86 and the talk-detail input area 88 using the software keyboard 92. After performing an input to the talk-detail input area 88, the operator transmits the talk details by operating a send button 94.

The talk-detail input area 88 may be provided with a placeholder text for prompting the user to input information necessary when delivering a report. Conventionally, a report from the tester has been expected to include “expected operation”, “operating circumstances”, “what actually happened”, “reproduction means”, and so on as information necessary for application development. In some cases, however, these items of information were not included in a report, and separate discussion was necessary. For this reason, wording for prompting the tester to input the above-described information is displayed in the talk-detail input area 88 as placeholder text. By doing so, the developer can decrease the frequency at which discussion is carried out with the user that has delivered a report. Note that the user can also transmit a talk without inputting anything at the placeholder text.

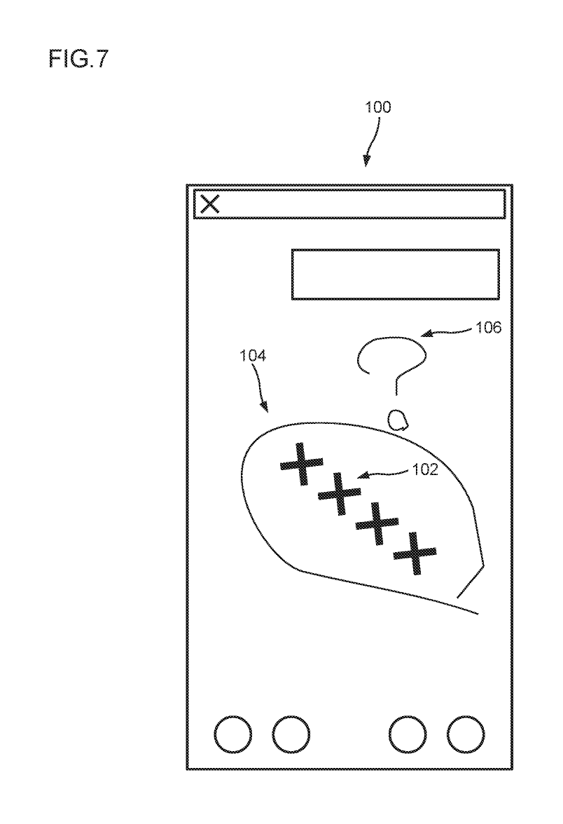

The image attach operation area 90 is provided with an image attach button 96 and an SC capture button 98. The image attach button 96 reads out an image that is stored in the auxiliary storage unit 24 and attaches it to a talk. The SC capture button 98 acquires a screen image (hereinafter, referred to as a “SC image”) 100 (refer to FIG. 7), which shows the application screen 40, by capturing the application screen 40 through a screenshot and attaches it to a talk. Note that when an image is attached, a talk can be transmitted without inputting anything in the talk-detail input area 88.

### 3-4. Transmission of an SC Image

The communication function can transmit an SC image 100 to which information is written. An operator clearly indicates a problematic portion to the developer by drawing on the acquired SC image 100 in freehand and basic shapes and by writing, such as inputting characters, on the acquired SC image 100. In the example shown in FIG. 7, a problematic portion 102 is surrounded by a substantially circular shape 104 drawn in freehand, with a drawn question mark 106 added. In this manner, as a result of writing on the SC image 100 being allowed, the user, even without having expert knowledge, can report, for example, a problem with the application screen 40 in an intuitive manner that the developer easily understands. In other words, even if the knowledge of the user is not equivalent to the knowledge of the developer, the user can give more appropriate feedback to the developer.

Note that the communication function captures, as the SC image 100, the image that is displayed on the display 26 when the startup button 42 is operated. For example, when a problem occurs in the application, the tester trying out the application operates the startup button 42 and reports the problem to the developer. More specifically, because the time at which the startup button 42 is operated and the time at which the problem occurs in the application are substantially the same, the user can give more appropriate feedback to the developer by capturing the SC image 100 at the time the startup button 42 is operated.

In addition, conventionally, when a problem occurred in the application, the user himself/herself, such as a tester, had to prepare an appropriate SC image 100 and a sentence easily understandable to the developer in order to present a problem reproduction procedure, such as “a problem occurred when the red button was pressed on the screen shown in the first screenshot and then the green icon was long-pressed on the screen shown in the second screenshot.” Such work requires expertise and practice, and some testers were not able to convey necessary and sufficient information to the developer.

In view of these circumstances, the communication function according to this embodiment may allow the SC image 100 to be captured each time a prescribed operation is performed on the application and a process based on the prescribed operation to be automatically performed on the SC image 100. The SC image 100 that has been automatically processed is referred to as a process SC image. In short, the communication function records problem reproduction procedures, without requiring any operation by the user, by automatically generating process SC images.

For example, when tapping or long-pressing, serving as a prescribed operation performed by an operator, is performed, the application screen 40 is captured as the SC image 100, and a process, e.g., marking the coordinate positions on the display 26 at which the operation was performed, is performed on this SC image 100, thereby producing the process SC image. In addition, when the object on which an operation is to be performed is an element, such as a button, on the application screen 40, a process of emphasizing the element, such as surrounding the element with a frame, is performed. Furthermore, information, such as the time at which the process SC image was generated, may be added to the process SC image.

The process SC image is stored in the auxiliary storage unit 24. Because the process SC image is generated for each prescribed operation, the procedures of operations performed on the application are stored as a result of the process SC images being stored time-sequentially. This allows appropriate feedback to the developer regardless of, for example, the degree of proficiency of the tester. In addition, also when the application is forcibly terminated (hereinafter, referred to as “crash”) due to a problem, the procedures of operations before the crash are stored as the process SC images, and hence the user can report problems about the crash when the application is started up again.

Note that the maximum number (e.g., 20) of process SC images stored in the auxiliary storage unit 24 is preset, and when the maximum number is reached, the oldest process SC image is deleted and a new process SC image is newly stored, thus updating and storing the process SC images, as needed.

In addition, the communication function may transmit a moving image showing changes in the application screen 40 (hereinafter, referred to as an “application screen moving image”). More specifically, when, for example, there is a problem with the motion of an animation showing the screen transition of the application screen 40, the operator starts to store the application screen moving image by, for example, operating a prescribed image displayed on the application screen 40. Thereafter, the storage of the application screen moving image is stopped by operating the above-described prescribed image again. Note that the prescribed image is, for example, the startup button 42, and acquisition of the application screen moving image may start when the startup button 42 is long-pressed, and acquisition of the application screen moving image may stop when the startup button 42 is long-pressed again. In addition, the application screen moving image may be automatically acquired at a set timing, regardless of the operation performed by the operator, or alternatively, the application screen moving image of a permitted user terminal 12 may be acquired on the basis of an operation from the developer terminal 14.

In addition, the application screen moving image may be associated with the process SC images so that the developer can easily find an intended scene for playback. For example, information indicating the times at which the process SC images for reproducing the problem were generated and the coordinate positions at which operations were performed on the application screen 40 is added to the application screen moving image as annotations.

### 3-5. Other Functions

The communication function transmits a log of the user terminal 12 in which the application is running. A log is, for example, system information of the user terminal 12 and includes information on the OS, the state of a memory such as the main storage unit 22, information indicating another application simultaneously running, and so on and is automatically generated by the OS. For example, when the application crashes for a reason unpredictable to the developer, this log is helpful in understanding the cause of the crash. In addition, a log may include a snap shot arbitrarily set by the developer to show the state of the application.

A log may be transmitted, as appropriate, to the developer terminal 14 by the user who performs a talk, together with the SC image 100 and the application screen moving image. For this purpose, the communication function may display a button for reading the log on the talk transmission operation screen 80.

In addition, the communication function may automatically transmit a log to the developer terminal 14 when the running application crashes. In this case, the communication function periodically reads the log and updates and stores the log in the main storage unit 22. Subsequently, the communication function continues to run even when the application crashes and automatically transmits, to the developer terminal 14, a talk to which a log at the time of the crash is appended, with the theme “Problem”. Thereafter, the communication function also stops running. Alternatively, when the application crashes, the communication function transmits, to the developer terminal 14, the log at the time of the crash by appending the log to a talk the next time the application is started up in the user terminal 12 in which the application crashed.

In addition, the developer may distribute an updated application using the communication function. An updated application may be distributed by the developer himself/herself by producing a new talk with the theme “Other”, may be distributed to all users, or may be distributed to particular users who have submitted a problem report or an improvement proposal. When only particular users are intended, the updated application is distributed to the users as a reply to a talk, and settings are made so that other users cannot download the updated application. By distributing the updated application only to particular users in this manner before distributing it to other users, the validity of an improvement can be determined with the minimum required number of persons, resulting in more efficient application development.

In addition, the communication function may display, in a synchronized (coordinated) manner, talk details on another application or web service pre-registered by the developer. Another application or web service is an entity for providing, for example, electronic mail, SNS (social networking system), and a shared web service for software development projects (hereinafter, referred to as “problem management system”). By doing so, it is possible to prevent the developer overlooking the talk details transmitted by the user, resulting in efficient application development.

In particular, in the problem management system, when a problem is solved and a series of talks (a thread) are closed in the communication function, the state on the problem management system side is also switched to a resolved state. In this manner, inconsistency and overlooking due to human errors in development management of the application can be prevented by allowing cross-sectional access to a single problem managed on different systems. For this purpose, the communication function may have a function for closing a thread. For example, a button that is operated when the user and the developer performing a talk agree that the problem has been solved is displayed on the thread screen 58, and when this button is operated, a thread is closed, and thereafter replies to this thread are disabled.

### 4. Functional Block Diagram Related to the Communication Function

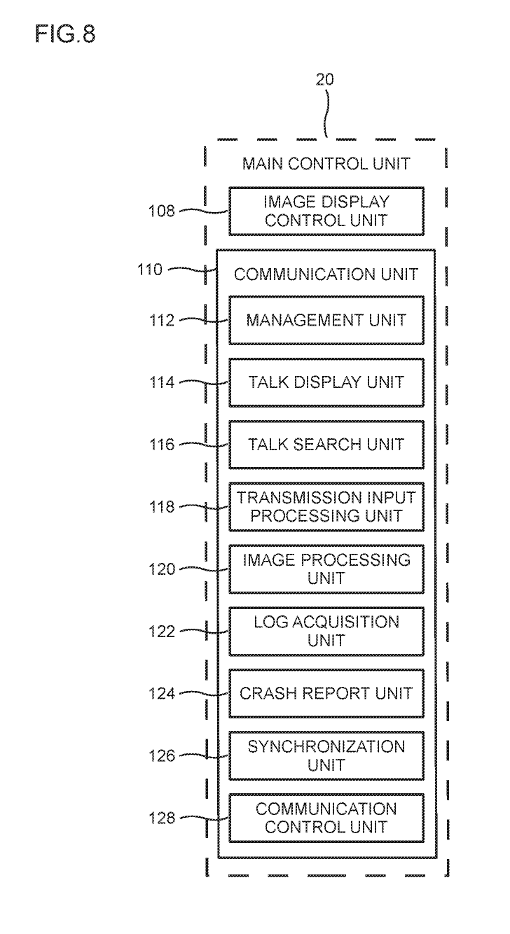

FIG. 8 is a functional block diagram related to the communication function according to this embodiment. The main control unit 20 includes an image display control unit 108 and a communication unit 110. Each of the functions provided in the main control unit 20 is realized by a program stored in the auxiliary storage unit 24.

The image display control unit 108 outputs, to the display 26, data indicating the image to be displayed. Images to be displayed on the display 26 in the communication function are, for example, the images shown in FIGS. 3 to 7. In addition, the image display control unit 108 displays the startup button 42 on the display 26 as soon as the application is started up.

The communication unit 110 performs the communication function and includes a management unit 112, a talk display unit 114, a talk search unit 116, a transmission input processing unit 118, an image processing unit 120, a log acquisition unit 122, a crash report unit 124, a synchronization unit 126, and a communication control unit 128.

The management unit 112 manages, for example, various types of settings related to the communication function and deletion of talks. The management unit 112 registers, for example, a terminal for transmitting and receiving a talk. Information used for the registration is identification information unique to the terminal, such as the IP address. In the communication function according to this embodiment, a user can participate in a talk using the communication function merely by registering the identification information of his/her user terminal 12.

In addition, the management unit 112 sets ON/OFF various types of functions provided in the communication function and sets information to be acquired as a log. Settings performed with the management unit 112 may be done when the communication program is to be incorporated into the application or may be done, as appropriate, after incorporation is completed. Settings and so on performed with the management unit 112 are stored in the server 16 and are reflected on the communication functions in all user terminals 12 and the developer terminal 14.

Although management authority via the management unit 112 is given to, for example, the developer who has incorporated the communication program into the application, management authority may also be given to a plurality of operators. In addition, the developer can browse, via the management unit 112, information about the user terminal 12, including OS information, such as the name and version of the OS, used in the user terminal 12 and the version information of the application used in that user terminal 12.

The talk display unit 114 outputs, to the image display control unit 108, data for displaying the main screen 44 on the display 26 when an operation is performed on the startup button 42 and data for displaying, on the display 26, screens (e.g., the thread screen 58 and the talk transmission operation screen 80) according to other operations.

The talk search unit 116 searches for a talk on the basis of the keyword input after the search button 56 is operated.

The transmission input processing unit 118 accepts the inputs of a theme, talk details, a SC image 100, and so on via the talk transmission operation screen 80.

The image processing unit 120 captures the SC image 100 when an operation is performed on the SC capture button 98. In addition, the image processing unit 120 accepts writing to the SC image 100, generates a process SC image, acquires an application screen moving image, and so on.

The log acquisition unit 122 acquires the log of the terminal when the application is running.

The crash report unit 124 transmits the log acquired by the log acquisition unit 122 when the application crashes.

The synchronization unit 126 synchronizes (coordinates) transmitted and received talk details with other pre-registered applications and web services.

The communication control unit 128 transmits, to the server 16 via the communicating unit 30, various types of information, such as the input content accepted by the transmission input processing unit 118, and stores, in the main storage unit 22 or the auxiliary storage unit 24, the talk details and so on received from another terminal via the server 16. Note that the server 16 that has received various types of information from the communication control unit 128 stores the type of the terminal, the identifier of the application, the version identifier automatically generated for each build of the application, user talks classified by theme, the SC image 100, and the log of the terminal running the application and transmits those items of information to the terminal at the transmission destination.

### 5. Communication Processing According to this Embodiment

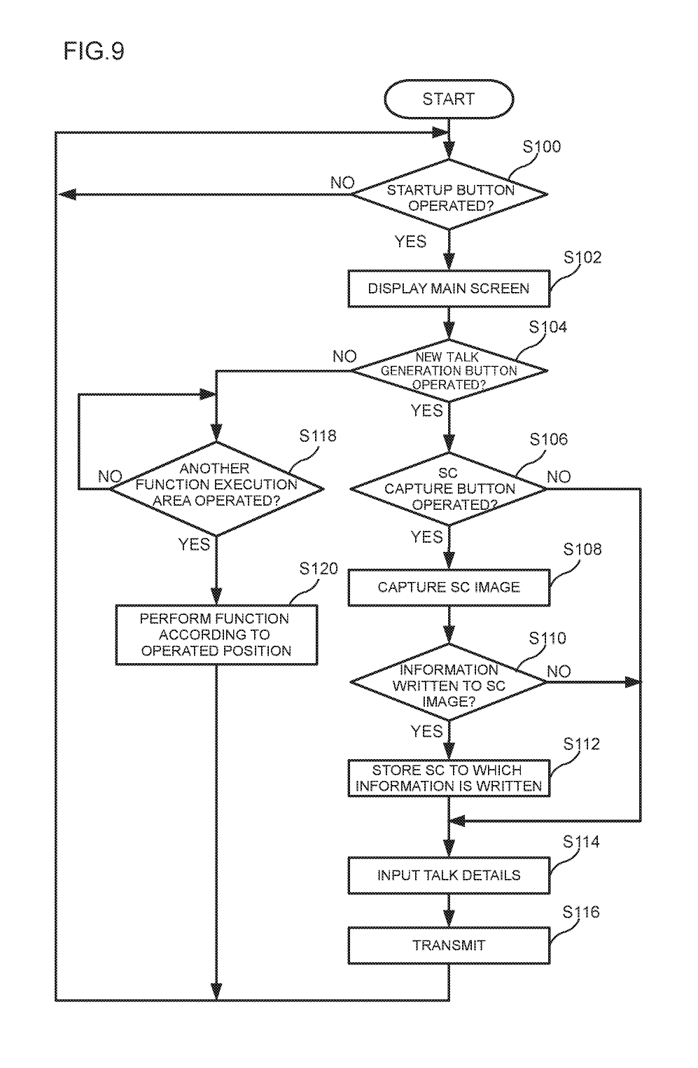

FIG. 9 is a flowchart showing a flow of processing (hereinafter referred to as “communication processing”) of the communication function executed by the main control unit 20. The communication processing starts as soon as the application into which this communication function is incorporated starts and ends as soon as this application ends. Note that although not explicitly indicated in the communication processing shown in FIG. 9, all of the above-described communication functions are included in this processing.

First, it is determined whether or not the startup button 42 displayed on the application screen 40 is operated in step 100, and the flow proceeds to step 102 in the case of an affirmative determination. In step 102, the main screen 44 is displayed on the display 26.

Next, in step 104, it is determined whether or not the new talk create button 54 is operated, and the flow proceeds to step 106 in the case of an affirmative determination or proceeds to step 118 in the case of a negative determination.

In step 106, it is determined whether or not the SC capture button 98 is operated, and the flow proceeds to step 108 in the case of an affirmative determination or proceeds to step 114 in the case of a negative determination. In step 108, the SC image 100 is captured.

In the next step 110, it is determined whether or not information has been written to the SC image 100, and the flow proceeds to step 112 in the case of an affirmative determination or proceeds to step 114 in the case of a negative determination. In step 114, the input of talk details to the input area 84 is accepted. In the next step 116, when the send button 94 is operated, the input talk details are transmitted, and the flow returns to step 100.

In step 118, to which the flow proceeds in the case of a negative determination in step 104, it is determined whether or not an area in which a function other than the new talk creation function of the communication functions (display and search of threads, replies, and so on) is performed has been operated, and the flow proceeds to step 120 in the case of an affirmative determination. In step 120, a function according to the operated position is performed, and the flow returns to step 100.

As described above, the communication program according to this embodiment is a communication program that is incorporated into an application, continuously displays the startup button 42 on the application screen 40, and runs as a function of the application when the startup button 42 is operated, thereby allowing a talk between the user and the developer. Because the communication function allows the developer and users to perform a talk in real time, the users of the application can easily give feedback, such as reports of usability and problems, to the developer in real time.

### 6. Other Embodiments

Although the present invention has been described using the above-described embodiments, the technical scope of the present invention is not limited to the scopes described in the above-described embodiments. A wide range of modifications and improvements can be applied to the above-described embodiments as long as they do not deviate from the gist of the invention, and the forms to which these modifications and improvements have been applied are also included in the technical scope of the present invention.

For example, although the above-described embodiments have been described by way of an example where the communication program is incorporated into an application, the present invention is not limited to this and may be in a form in which the communication program is incorporated into a web site. In the case of this form, when the web site into which the communication program is incorporated is opened, the startup button 42 is displayed on the web site, which is switched to a web page displaying the main screen 44 when that startup button 42 is operated. Alternatively, as a result of the startup button 42 being operated, an application for executing the communication function is started up, and the main screen 44 is displayed.

In addition, although the above-described embodiments have been described by way of an example where the main screen 44 is switched to the thread screen 58, which is displayed on the display 26, the present invention is not limited to this. The above-described embodiments may be in a form in which the thread screen 58 is displayed on the display 26 so as to be located to the left of the main screen 44 and, when the operator operates a talk display 50 on the main screen 44, the thread screen 58 is switched so as to correspond to the operated talk display 50, instead of switching the main screen 44.

In addition, although the above-described embodiments have been described by way of an example where the communication function runs as a function of the application, the present invention is not limited to this. The above-described embodiments may be in a form in which the communication function is realized by a communication program different from the application. In other words, the communication program is a program for realizing the communication functions described with reference to FIGS. 3 to 9 and so on and is separately started up when the startup button 42 displayed on the application screen 40 is operated. In this form, the terminal includes startup means for starting up the communication program when the startup button 42 is operated. Note that the communication program may be, for example, an existing application program for realizing an SNS, as long as it can achieve communication between users and the developer.

In addition, the flow of the communication processing described in the above-described embodiments is just one example, and hence unnecessary steps may be deleted, new steps may be added, and the processing order may be changed, as long as changes do not deviate from the gist of the present invention.

### DESCRIPTION OF REFERENCE SIGNS

10 Communication system
20 Main control unit (computer)
40 Application screen (screen)
42 Startup button (prescribed image)
108 Image display control unit (image display control unit)
110 Communication unit (communication unit)

What is claimed is:

1. A computer program product comprising a non-transitory computer-readable medium storing communication program code that is incorporated into an application program, the communication program code being for causing a computer to function as:
an image display control unit for continuously displaying a prescribed image on a screen on which the application program is operating; and
a communication unit operating as a function of the application program when the prescribed image is operated and allowing communication between a user and a developer.

2. The computer program product according to claim 1, wherein the communication program code is for causing the computer, when the user performs communication using the communication unit, to perform functions of causing the communication unit in the application program on the developer side to display communication content from the user so as to allow the developer to make a reply.

3. The computer program product according to claim 1, wherein the communication program code is for causing the computer to perform functions of causing the communication unit to display communication content made by another user.

4. The computer program product according to claim 1, wherein the communication program code is for causing the computer to perform functions of causing the communication unit to allow an operator to search for past communication content.

5. The computer program product according to claim 1, wherein the communication program code is for causing the computer to perform functions of moving the prescribed image to a position according to a drag operation performed by an operator.

6. The computer program product according to claim 1, wherein the communication program code is for causing the computer to perform functions of causing the communication unit to transmit a screen image showing the screen on which the application program is operating.

7. The computer program product according to claim 6, wherein the communication program code is for causing the computer to perform functions of causing the communication unit to transmit the screen image to which writing is performed.

8. The computer program product according to claim 6, wherein the communication program code is for causing the computer to perform functions of causing the communication unit to capture the screen image for each prescribed operation performed on the application program and perform a process based on the prescribed operation on the screen image.

9. The computer program product according to claim 1, wherein the communication program code is for causing the computer to perform functions of causing the communication unit to transmit a moving image showing a change in the screen on which the application program is operating.

10. The computer program product according to claim 1, wherein the communication program code is for causing the computer to perform functions of causing the communication unit to transmit a log of an information processing apparatus in which the application program is operating.

11. The computer program product according to claim 10, wherein the communication program code is for causing the computer to perform functions of causing the communication unit to transmit the log when the operating application program abnormally ends.

12. The computer program product according to claim 1, wherein the communication program code is for causing the computer to perform functions of causing the communication unit to synchronize communication content with another pre-registered application program or another pre-registered web service.

13. The computer program product according to claim 1, wherein the communication program code is incorporated into a web site instead of the application program.

14. A computer program product comprising a non-transitory computer-readable medium storing communication program code that is incorporated into an application program, the communication program code being for causing a computer to function as:
an image display control unit for continuously displaying a prescribed image on a screen on which the application program is operating; and
a startup unit for starting up a communication program that allows communication between a user and a developer when the prescribed image is operated.

15. An information processing apparatus in which an application program having a communication program incorporated thereinto is installed, the information processing apparatus comprising:
an image display control unit for continuously displaying a prescribed image on a screen on which the application program is operating; and
a communication unit operating as a function of the application program when the prescribed image is operated and allowing communication between a user and a developer.

16. A communication method using a communication program incorporated into an application program, the communication method comprising:
a first step of continuously displaying a prescribed image on a screen on which the application program is operating; and
a second step of operating as a function of the application program when the prescribed image is operated and allowing communication between a user and a developer.
